(19) United States
(12) Patent Application Publication
(10) Pub. No.: US 2013/0025719 A1
(43) Pub. Date: Jan. 31, 2013

(54) FLOW RATE STABILIZER AND CONNECTING TUBE COMPRISING THE SAME

(71) Applicant: Tsai-Chen YANG, Taichung City (TW)

(72) Inventor: Tsai-Chen YANG, Taichung City (TW)

(21) Appl. No.: 13/192,918

(22) Filed: Jul. 28, 2011

(51) Int. Cl. F15D 1/00

(52) U.S. Cl. 137/599.01

(57) ABSTRACT

A connecting tube with a flow rate stabilizer of the present invention includes a flow rate stabilizer and a connecting portion.

The flow rate stabilizer has a main body and an elastic ring. The elastic ring is received in the receiving groove of the main body. The connecting portion is divided into a first part and a second part. As such, the present invention uses the elastic ring moving in the receiving groove. Pushing by the water, the elastic ring is able to move in the receiving groove so as to obstruct the flow way partially, and the flow rate would be stable. The structure of the connecting portion enables the present invention to be adapted to various water pipes. As such, manufacturing is uncomplicated, and lifetime is prolonged. Therefore, the present invention is more competitive.

### BACKGROUND OF THE INVENTION

1. Field of the Invention

The present invention relates to a flow rate stabilizer with a connecting tube, which is provided for fresh water pipes to make the flow rate stabilized.

2. Description of the Prior Art

Conventional flow rate stabilizer, as disclosed in TW 1338756, is provided for being installed in the flow way by using an elastic member to abut against a slidable fulcrumor plunger. The stabilizer has an elastic member for pushing a sliding plunger and fulcrum. When the water pressure of the water supply is increased, the plunger is pushed by water. The plunger is then moved to obstruct the flow way partially. As such, increment of flow rate is slashed even the water pressure is suddenly increased. When the water pressure of the water supply is decreased, the plunger is pushed by the elastic member. The plunger is then moved forward to open the flow way. As such, decrement of flow rate is minimized. The flow rate is stabilized overall. Therefore, the flow rate stabilizer can be applied to be disposed in faucets, shower nozzles, and normal water pipes.

However, when disposing the flow rate stabilizer in faucets or shower nozzles, the fixing method of inserting and compressing is inconvenient to disassemble.

Furthermore, speaking of the situation that an inner dimension of an installing hole is too small, the flow rate stabilizer would not be applicable.

The present invention is, therefore, arisen to obviate or at least mitigate the above mentioned disadvantages.

### SUMMARY OF THE INVENTION

The main object of the present invention is to provide a connecting tube with a flow rate stabilizer which has a function of stabilizing a water flow and an ability of adapting to various sizes of water pipes and shower nozzles.

To achieve the above and other objects, a connecting tube with a flow rate stabilizer of the present invention includes a flow rate stabilizer and a connecting portion.

The flow rate stabilizer has a main body and an elastic ring. The main body is formed with a top surface and a bottom surface, the main body is formed with an annular guiding wall, an annular abutting wall, and an annular bottom wall. The annular receiving groove is defined by the guiding wall, the abutting wall, and the bottom wall. The receiving groove extends axially from the top surface, having an opening. The guiding wall extends conically from the opening to the bottom wall, and the abutting wall extends axially form the opening to the bottom wall. The bottom wall has an arc-shaped cross-section. The main body is formed with a plurality of penetrating holes which extend axially and communicate axially with the receiving groove. At least a part of a figure of each penetrating hole covers a figure of the guiding wall axially.

The elastic ring is received in the receiving groove. Parts of the elastic ring near the penetrating holes are movable between a first position and a second position along the bottom wall, abutting against to the bottom wall when the elastic ring is located at the first position. The elastic ring abuts against the bottom wall and moves into the penetrating holes when the elastic ring is located at the second position. As a result, a part of each penetrating hole is blocked by the elastic ring when the elastic ring is located at the second position. Also, the elastic ring has a tendency to move back to the first position at anytime.

The connecting portion is divided into a first part and a second part. The first part has a first opening, and the second part has a second opening. The first opening communicates with the second opening. The flow rate stabilizer is disposed between the first part and the second part.

By what is mentioned above, the present invention provides a connecting tube with a flow rate stabilizer. The connecting tube with the flow rate stabilizer uses the elastic ring moving in the receiving groove. Therefore, the elastic ring is able to move in the receiving groove so as to obstruct the flow way partially making the flow rate stabilized. The structure of the connecting portion enables the present invention to be adapted to various water pipes. As such, manufacturing is uncomplicated, and lifetime is prolonged.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a decomposition drawing of the present invention;

FIG. 2 is a cross sectional drawing of the present invention;

FIG. 3 is a partial cross sectional drawing showing a using state of the present invention;

FIG. 4 is decomposition drawing of a flow rate stabilizer of the present invention;

FIG. 5 is a front view showing a flow rate stabilizer of the present invention;

FIG. 6 to FIG. 8 are partial cross sectional drawings showing a using condition of the present invention;

FIG. 9 is a stereogram showing a connecting portion of a first example of the present invention;

FIG. 9A is a cross sectional drawing of FIG. 9;

FIG. 10 is a stereogram showing a connecting portion of a second example of the present invention;

FIG. 10A is a cross sectional drawing of FIG. 10;

FIG. 11 is another stereogram of the present invention;

FIG. 11A is a cross sectional drawing of FIG. 11;

FIG. 12 is a stereogram showing a connecting portion of a third example of the present invention;

FIG. 12A is a cross sectional drawing of FIG. 12;

### DETAILED DESCRIPTION OF THE PREFERRED EMBODIMENTS

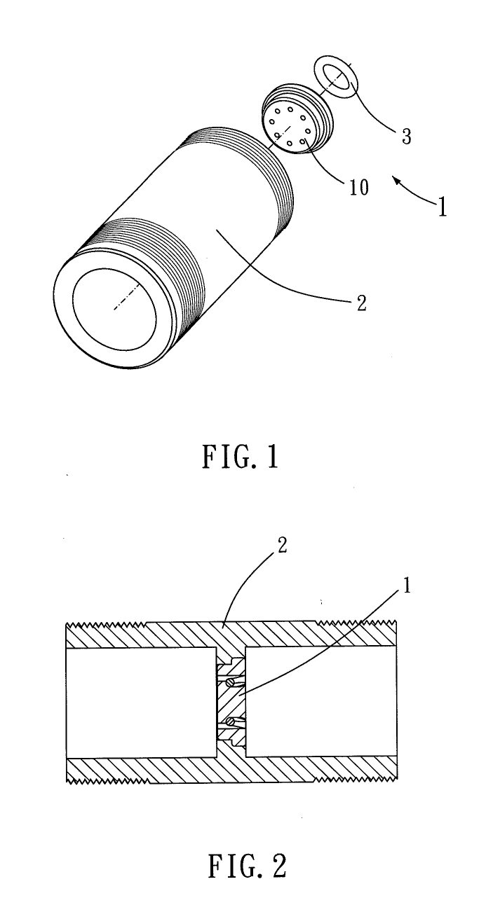

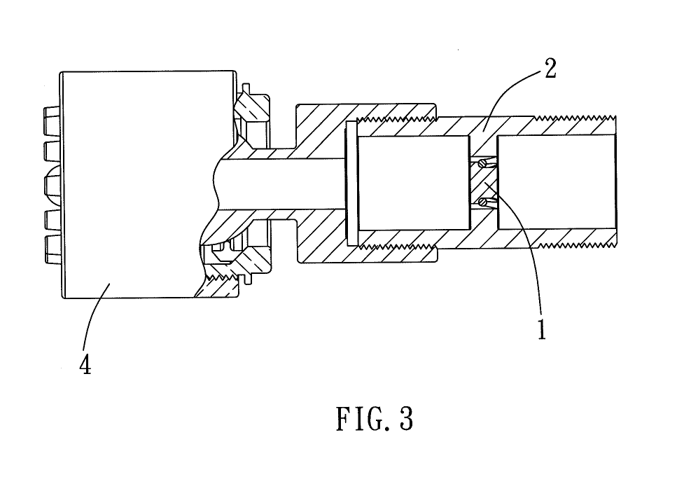

Please refer to FIG. 1 and FIG. 3. The flow rate stabilizer with a connecting tube of the present invention is comprised of a flow rate stabilizer 1 and a connecting portion 2. The flow rate stabilizer with a connecting tube is provided to be disposed in a flow way. For example, the flow rate stabilizer 1 can be assembled in a shower nozzle 2. The flow rate stabilizer 1 can also be assembled in a water pipe.

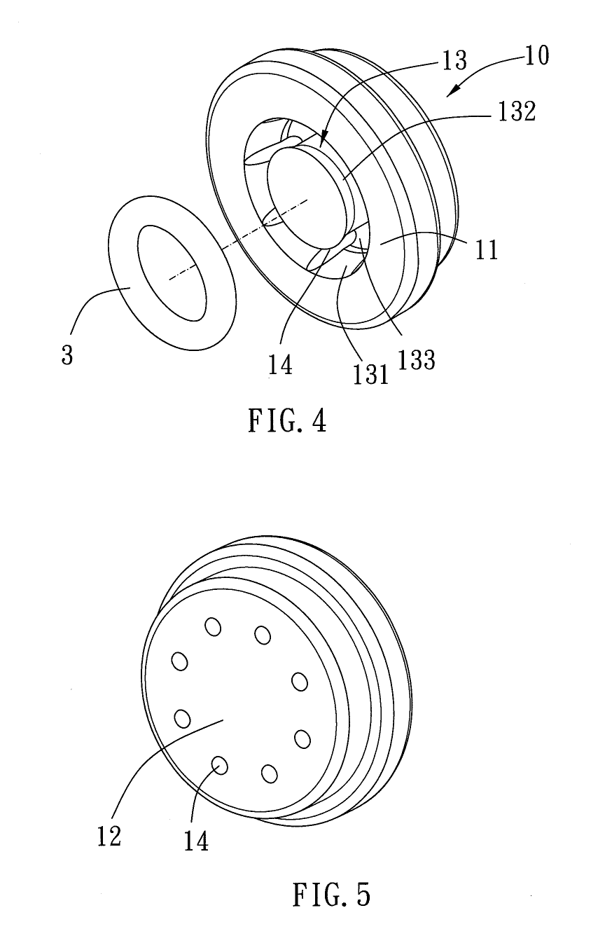

Please refer to FIG. 4 to FIG. 5, the flow rate stabilizer 1 includes a main body 10 and an elastic ring 3. The main body 10 has a top surface 11 and bottom surface 12. The top surface 11 is formed with an annular receiving groove 13. The receiving groove 13 extends axially from the top surface 11. The receiving groove 13 is formed with a guiding wall 131, an abutting wall 132, and a bottom wall 133. The receiving groove 13 is defined by the guiding wall 131, the abutting wall 132, and the bottom wall 133. The receiving groove 13 has an opening. The guiding wall 131 extends conically from the opening to the bottom wall 133. The abutting wall 132 extends axially from the opening to the bottom wall 133. In the present embodiment, a diameter of the guiding wall 131 is larger than that of the abutting wall. In other words, the abutting wall 132 is located inside of the guiding wall 131. The receiving groove 13 is located between the abutting wall 132 and the guiding wall 131. Preferably, the bottom wall 133 has an arc-shaped cross section.

The main body 10 is further formed with a plurality of penetrating holes 14. Each penetrating hole 14 extends axially and communicates axially with the receiving groove 13. That is, each penetrating hole 14 has an outline which is enclosed in an outline of the receiving groove 13. In other words, outlines of the penetrating holes 14 are located in the outline of the receiving groove 13, and do not pass through the outline of the receiving groove 13. At least a part of a figure of each penetrating hole 14 covers a figure of the guiding wall axially. Preferably, the guiding wall 131 has an outline which is adjacent to the opening touches tangentially with outlines of the penetrating holes 14. That is, the penetrating holes 14 are arranged inside of an outer periphery of the receiving groove 13. Each penetrating hole 14 has a considerable size. Preferably, each penetrating hole 14 has a figure covering both figure of the guiding wall 131 and figure of the bottom wall 133, as shown in FIG. 4. In other words, each penetrating hole 14 may penetrate through both and between the guiding wall 131 and the bottom wall 133.

The elastic ring 3 is received in the receiving groove 13. The abutting wall 132 extends axially form the opening to the bottom wall 13 so that a radius is getting smaller when the abutting wall 132 is getting closer to the bottom wall 13. For the sake of elasticity of the elastic ring 3, the elastic ring 3 stays in a smaller radius area of the receiving groove 13 without affecting by external force in order to avoid that the elastic ring 3 falls from the receiving groove 13. A part of the elastic ring 3 which is near to the penetrating holes is able to move between a first position and a second position along the bottom wall 133. Precisely, the elastic ring 3 is flexible, so the elastic ring 3 is able to stretch. A part of the elastic ring 3 which is closed to penetrating holes 14 can move to each penetrating hole 14 along the bottom wall 133, abutting against the bottom wall 133 and approaching each penetrating hole 14. Therefore, each penetrating hole 14 is blocked by the elastic ring 3 partially. For the sake of elasticity of the elastic ring 3, the elastic ring 3 has a tendency of moving back to the first position when the elastic ring 3 does not affect by external force.

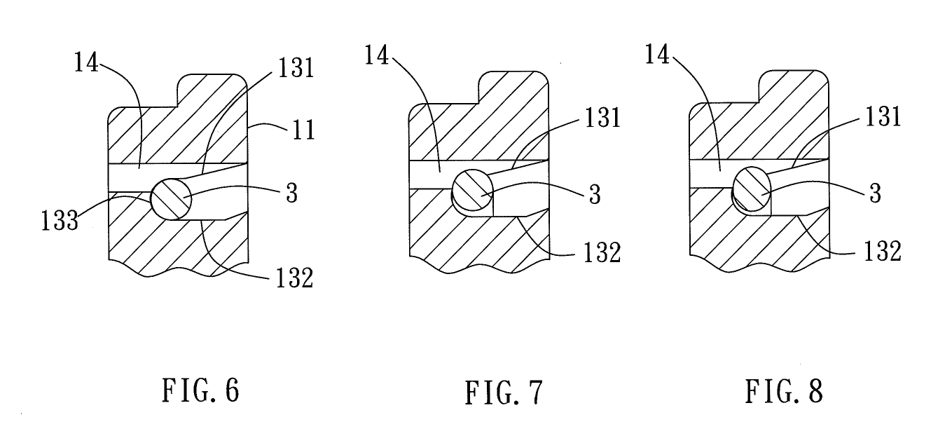

Accordingly, the flow rate stabilizer 1 of the present invention can be disposed in a flow way. The top surface 11 is made toward the water source. When water is closed or is not entered, or the water pressure is low, the position of the elastic ring 3 is mainly determined by the elastic force of the elastic ring 3. The elastic ring 3 is located at the first position. The elastic ring 3 is located in the receiving groove 13 so that the elastic ring 3 is near to the bottom wall 133, as shown in FIG. 6. In this condition, water can pass through an annular gap between the elastic ring 3 and the guiding wall 131. Water then flow out of the receiving groove 13 via the penetrating holes 14.

When water pressure or the speed of water flow is increased, water would push the elastic ring 3 to move along the bottom wall 133 toward the second position, as shown in FIG. 7. In this condition, water can still pass though an annular gap between the elastic ring 3 and the guiding wall 131. However, the gap here is narrowed with the elastic ring 3 moving to the second position. Therefore, water flow is obstructed so that the water flow would not increase with the water pressure. When the water pressure or the speed of water flow is further increased, the elastic ring 3 would move to the second position and abut against the bottom wall 133, approaching to each penetrating hole. The radius of the elastic ring 3 would be enlarged with increasing of the water pressure. The elastic ring 3 also has a compressing condition when the water pressure is over-enlarged. Thus, parts of the elastic ring 3 are closed to each penetrating hole 14, and the cross-section of the elastic ring 3 becomes a flatter oval-shaped. And each penetrating hole 14 has a partial area blocked by the elastic ring 3, as shown in FIG. 8. Water can only pass via a unblocked area of each penetrating hole 14 so that the water flow is further obstructed to keep the water flow stable. Moreover, to increase oval-forming effects of the elastic ring 3 when the elastic ring 3 is affected by the water flow, length of the penetrating holes 14 can be increased. Therefore, surface area that elastic ring 3 abuts against the bottom wall 133 would be decreased. The elastic ring 3 could be deformed by the strong water flow. As a result, when the water flow is increased, the elastic ring 3 would lead to effects of obstruction easier. The water flow from the penetrating holes 14 would be much more stable as well.

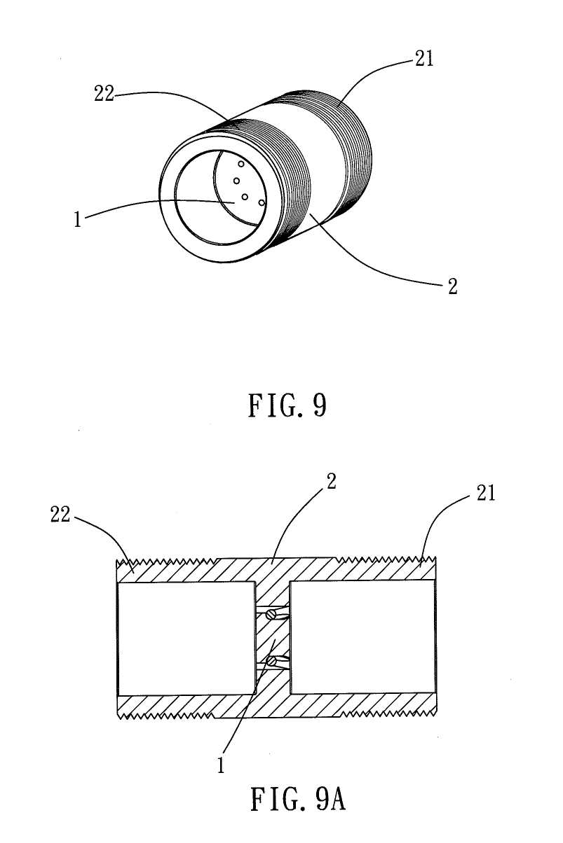

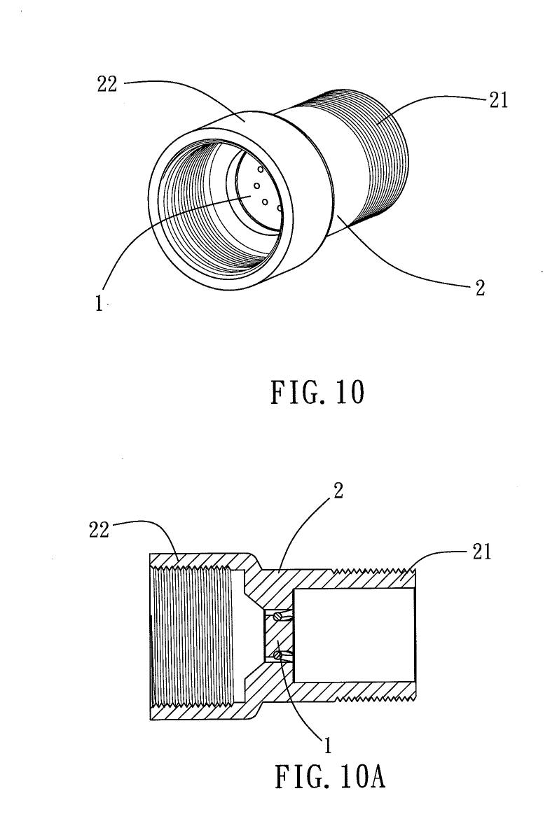

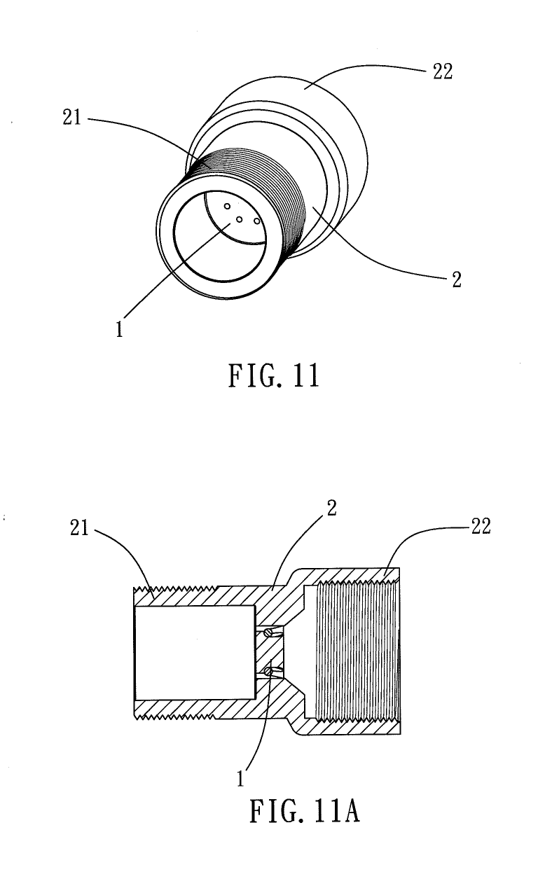

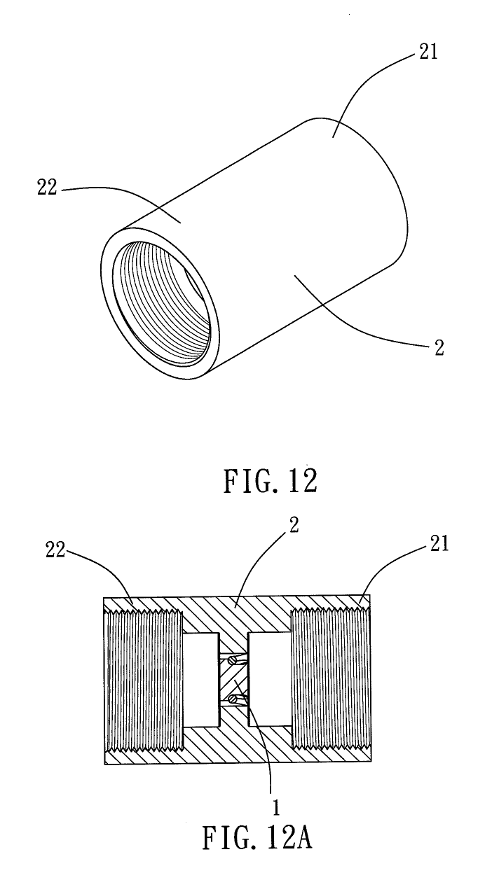

In order to adapt the stabilizer to various sizes of water pipes or shower nozzles, the present invention is further comprising a connecting portion which is adaptable for various sizes of water pipes or shower nozzles. The connecting portion is divided into a first part 21 and a second part 22. The first part 21 has a first opening, and the second part has a second opening. The first opening communicates with the second opening. The stabilizer 1 is disposed between the first part 21 and the second part 22. The stabilizer 1 and the connecting portion 2 can be fabricated together after being manufactured separately. Also, the stabilizer 1 and the connecting portion 2 can be formed integrally in a process of production. There are three kinds of the connecting portion 2 described as the followings: Firstly, the first part 21 has an outer thread, and the second part 22 has an outer thread, as shown in FIG. 9 and FIG. 9A. Secondly, the first part 21 has an outer thread, and the second part 22 has an inner thread, as shown in FIG. 10 and FIG. 10A. Thirdly, the first part 21 has an inner thread, and the second part 22 has an inner thread, as shown in FIG. 12 and FIG. 12A. Moreover, in another embodiment, as shown in FIG. 11 and FIG. 11A, it is also possibility that the top surface 11 and the bottom surface 12 of the stabilizer 1 can be exchanged with each other in order to make the top surface 11 toward the first part 21 and the bottom surface 12 toward the second part 22.

When disposing the connecting tube of the present invention in the flow way, the first part 21 and the second part 22 are positioned in the corresponding pipe size respectively, and then functions can be carried out by the connecting portion 2 with the stabilizer 1. To be clearer, when an inner dimension of the water pipe is larger than that of the connecting portion 2, the water pipe can be screwed to the connecting portion 2 by the outer thread of the connecting portion 2. When an inner dimension of the water pipe is smaller than that of the connecting portion 2, the water pipe can be screwed to the connecting portion 2 by the inner thread of the connecting portion 2.

To conclude, the present invention arranges the stabilizer 1 in the connecting portion 2. With the suitable connecting portion 2, the present invention can be disposed in various flow ways or shower nozzles. And using only the main body 10 and the elastic ring 3 in the stabilizer 1 reaches purposes of keeping the supplement of the water flow stabilized and keeping the water flow stabilized in the flow way. Accordingly, the present invention is simplified in structure. The stabilizer 1 and the connecting portion 2 can also be formed integrally, leading whole structure to be more stable, and lifetime is prolonged also. On the other hand, manufacturing and producing the flow rate stabilizer is easier without other complex structures. As a result, the cost of production can be well-controlled to gain better market competition.

What is claimed is:

1. A flow rate stabilizer, comprising:
a main body, having a top surface and a bottom surface, the main body being formed with an annular guiding wall, an annular abutting wall, and an annular bottom wall, an annular receiving groove being defined by the guiding wall, the abutting wall, and the bottom wall, the receiving groove extending axially from the top surface, the receiving groove having an opening, the guiding wall extending conically from the opening to the bottom wall, the abutting wall extending axially form the opening to the bottom wall, the bottom wall having an arc-shaped cross-section, the main body being formed with a plurality of penetrating holes, each penetrating hole extending axially, each penetrating hole communicating axially with the receiving groove, at least a part of a figure of each penetrating hole covering a figure of the guiding wall axially;
an elastic ring, received in the receiving groove, parts of the elastic ring near the penetrating holes being movable between a first position and a second position along the bottom wall, the elastic ring abutting against to the bottom wall when the elastic ring is located at the first position, the elastic ring abutting against the bottom wall and moving into the penetrating holes when the elastic ring is located at the second position, a part of each penetrating hole being blocked by the elastic ring when the elastic ring is located at the second position, the elastic ring having a tendency to move back to the first position at anytime.

2. A connecting tube, comprising the flow rate stabilizer of claim 1, further comprising a connecting portion, the connecting portion being divided into a first part and a second part, the first part having a first opening, the second part having a second opening, the first opening communicating with the second opening, the flow rate stabilizer being disposed between the first part and the second part.

3. The connecting tube of claim 2, wherein the first part having an outer thread, the second part having an outer thread.

4. The connecting tube of claim 2, wherein the first part having an outer thread, the second part having an inner thread.

5. The connecting tube of claim 2, wherein the first part having an inner thread, the second part having an inner thread.
